(19) United States
(12) Patent Application Publication
(10) Pub. No.: US 2016/0232548 A1
(43) Pub. Date: Aug. 11, 2016

(54) ADAPTIVE PRICING ANALYTICS

(71) Applicant: SCIENTIFIC REVENUE, INC., San Mateo, CA (US)

(72) Inventor: William Grosso, San Mateo, CA (US)

(21) Appl. No.: 15/026,066

(22) PCT Filed: Oct. 7, 2014
(86) PCT No.: PCT/US2014/059564

§ 371 Date: Mar. 30, 2016

Related U.S. Application Data
(60) Provisional application No. 61/888,512, filed on Oct. 9, 2013.
(60) Provisional application No. 61/888,503, filed on Oct. 9, 2013.
(60) Provisional application No. 61/888,499, filed on Oct. 8, 2013.

(51) Int. Cl. G06Q 30/02; G06N 7/00; G06N 99/00

(52) U.S. Cl. CPC G06Q 30/0206; G06N 99/005; G06N 7/005

(57) ABSTRACT

A system for adaptive pricing analytics comprising a pricing engine that may generate payment structures and price values, a customer segmentation server that may analyze user behavior, and a pricing analysis server that proposes new price values based on analysis results, and a method for adaptive pricing analytics.

### CROSS-REFERENCE TO RELATED APPLICATIONS

This application claims the benefit of, and priority to, U.S. provisional patent application Ser. No. 61/888,512, titled “MULTI-ARM BANDIT TESTING AND CONJOINT ANALYSIS”, filed on Oct. 9, 2013, and claims the benefit of, and priority to, U.S. provisional patent application Ser. No. 61/888,503, titled “CREATION OF A COMPLETE METRIC SET FOR DESKTOP PRICING ANALYTICS”, filed on Oct. 9, 2013, and also claim the benefit of, and priority to, U.S. provisional patent application Ser. No. 61/888,499, titled “AMBIENT DATA GATHERING AND MACHINE LEARNING”, filed on Oct. 9, 2013, the entire specifications of each of which are incorporated herein by reference in their entirety.

### BACKGROUND OF THE INVENTION

1. Field of the Art

The disclosure relates to the field of dynamic pricing, and more particularly to the field of utilizing machine learning for dynamic pricing.

2. Discussion of the State of the Art

The emergence of large-scale online gaming communities, and the more recent arrival of mobile gaming as a major market, have presented dramatic opportunities for merchants. Users of online and mobile games have shown a willingness to make in-app (or in-game) purchases, generally of virtual goods (e.g., points, game items, game capabilities, etc.), and provide vendors with a rich variety of behavior data. In such a data rich, behaviorally complex environment, pricing becomes a very complex art. In the art, few tools are available to facilitate pricing of in-app or in-game items, and most such pricing is done manually and in an ad hoc fashion. A great deal of “tribal knowledge” rules in this area, with thumbrules and ideas that may work in the physical commerce world of bricks-and-mortar retailers are assumed to be valid in the online and mobile gaming worlds (and similar areas, such as online gambling, online education, digital media, and the like).

What is clearly needed is a system that brings science to the world of pricing in online environments, and that enables highly automated, adaptive, dynamic and behavior-driven analysis of in-game, in-app, or equivalent item prices and pricing arrangements.

### SUMMARY OF THE INVENTION

Accordingly, the inventor has conceived and reduced to practice, in a preferred embodiment of the invention, a system and method for adaptive pricing analytics via a dynamic pricing system that produces parameterized price values and rules according to metrics derived from customer behavior analysis.

According to a preferred embodiment of the invention, a system for dynamic psychologically-friendly pricing via a dynamic pricing system that produces price values based on customer behavior, in an online digital entertainment environment, comprising a pricing console computer comprising program code stored in a memory and adapted to operate an interface for receiving user interaction, a database computer comprising program code stored in a memory and adapted to store information from the other components of the system, a pricing engine computer comprising program code stored in a memory and adapted to generate at least a plurality of parameterized price values, a pricing analysis server computer comprising program code stored in a memory and adapted to analyze at least the price values and provide the analysis results to the pricing console, and a customer segmentation server computer comprising program code stored in a memory and adapted to receive customer interactions via a digital packet network and to generate customer behavior data values based at least in part on those interactions, and to provide the behavior data values to the pricing engine, is disclosed.

According to another preferred embodiment of the invention, a method for adaptive pricing analytics, comprising the steps of generating, using a pricing engine computer comprising program code stored in a memory and adapted to generate at least a plurality of parameterized price values, an initial set of pricing values, receiving, at a customer segmentation server computer comprising program code stored in a memory and adapted to receive customer interactions via a digital packet network and to generate customer behavior data values based at least in part on those interactions, and to provide the behavior data values to the pricing engine, a plurality of customer data values, categorizing customers based at least in part on received data values, generating a metric set based at least in part on the received data values, and updating the pricing values based at least in part on the metric set, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a diagram of an exemplary system for adaptive pricing analytics, according to a preferred embodiment of the invention.

FIG. 6 is a method flow diagram illustrating an exemplary method for adaptive pricing analytics, according to a preferred embodiment of the invention.

FIG. 7 is an illustration of an exemplary user interface for viewing parameterized pricing rules.

FIG. 8 is an illustration of an exemplary user interface for viewing customer segments.

### DETAILED DESCRIPTION

The inventor has conceived, and reduced to practice, in a preferred embodiment of the invention, a system and method for adaptive pricing analytics via a dynamic pricing system that produces parameterized price values and rules according to metrics derived from customer behavior analysis.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

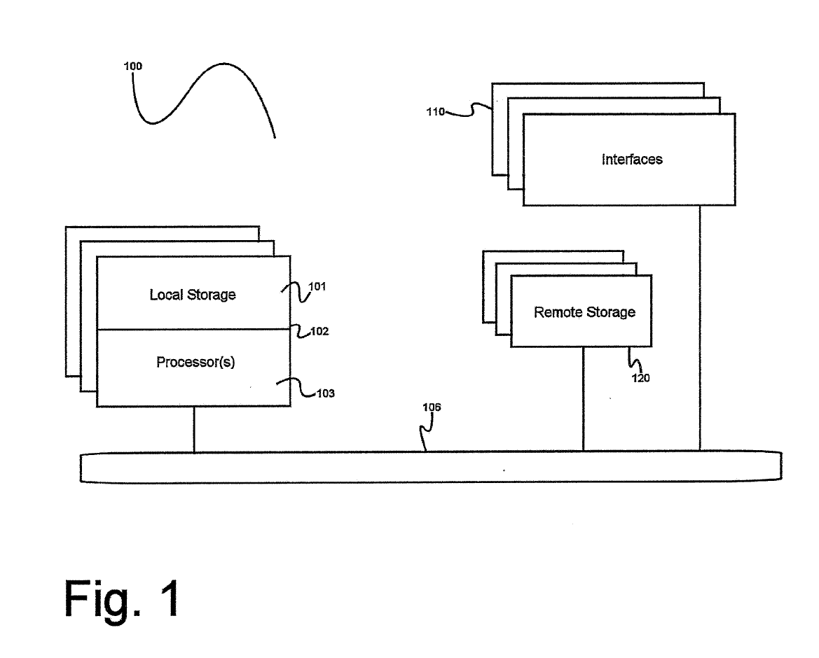

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

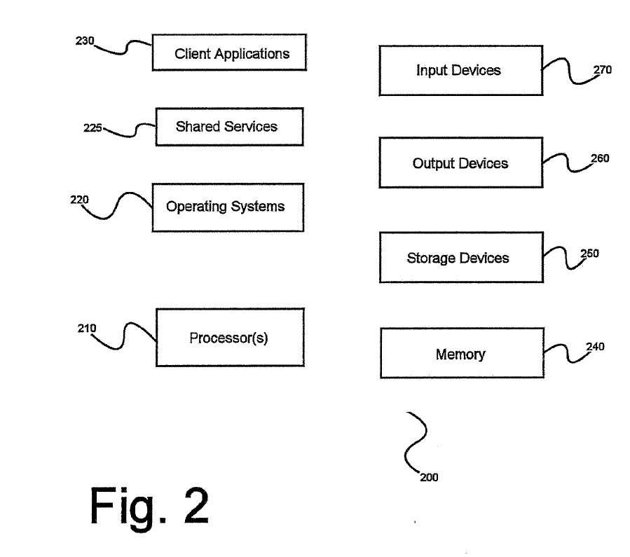

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

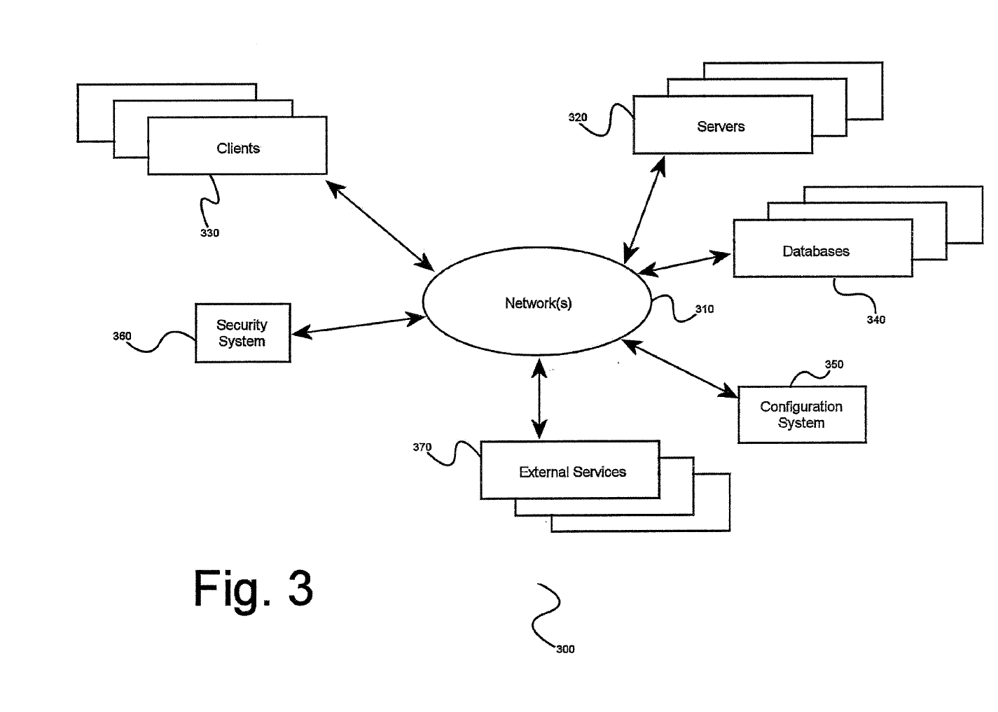

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

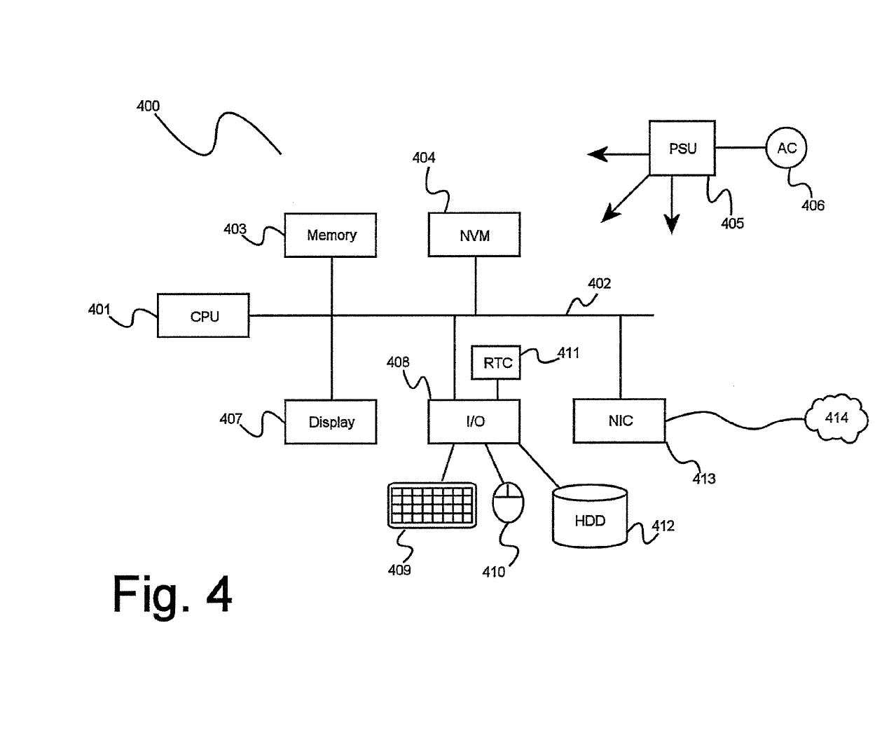

FIG. 4 shows an exemplary overview of a computer system 400 as may be used in any of the various locations throughout the system. It is exemplary of any computer that may execute code to process data. Various modifications and changes may be made to computer system 400 without departing from the broader scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

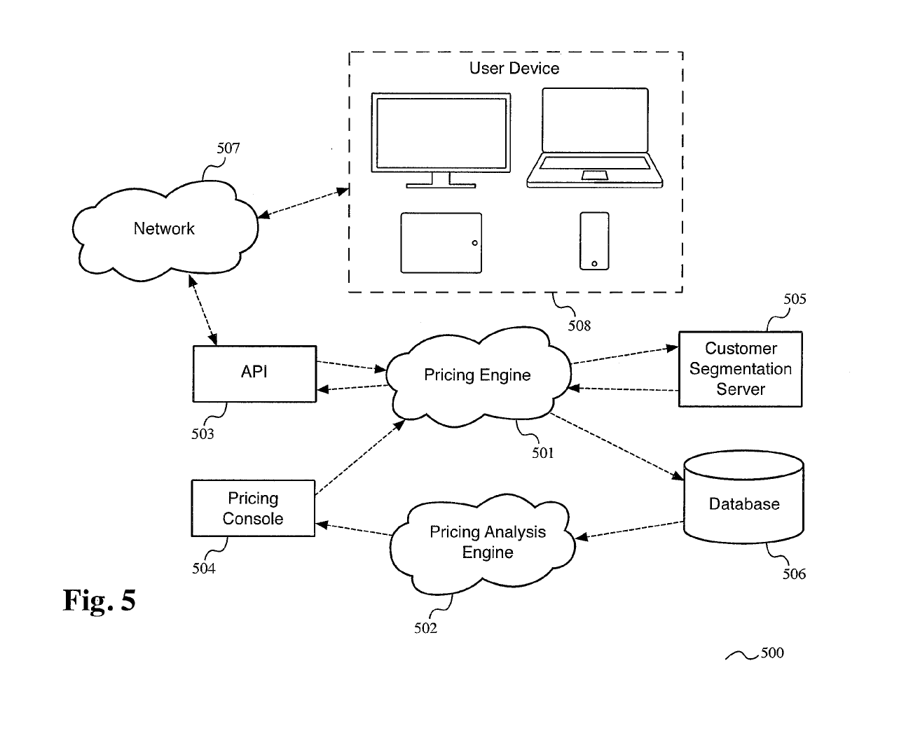

FIG. 5 is a system architecture diagram illustrating an exemplary system 500 for adaptive pricing analytics, according to a preferred embodiment of the invention. According to the embodiment, a pricing engine 501 computer may be a computer comprising at least program code stored in a memory and adapted to generate a plurality of price values such as for use in payment systems for online entertainment (hereinafter referred to as “paywalls”), and may be connected such as via a digital packet network (such as the Internet or other suitable communication network) to other components of a system 500, such as a database 506 that may be a computer comprising at least program code stored in a memory and adapted to facilitate storage of information from a pricing engine 501 or other components of a system 500. System 500 may further comprise a software application programming interface (API) 503 that may comprise at least program code adapted to facilitate integration or communication with any of a variety of external or third-party products or services, such as including but not limited to software-based services such as social media networks or websites, or physical devices such as personal computers or smartphones, or any other such device that may operate program code and communicate via a network, and any variety or quantity of such external or third-party products or services may be utilized simultaneously or interchangeably according to the embodiment.

Further according to the embodiment, a customer segmentation server 505 may be a computer comprising at least program code stored in a memory and adapted to receive and interpret customer behavior data (such as may be provided by an API 503), for example to categorize, sort, or otherwise identify customers or other users based on observable behavior information. Customer segmentation server 505 may then provide customer segmentation information to a pricing engine 501 such as for use in producing price values, for example to determine appropriate values based on known customer behavior to increase likelihood of a purchase, or to offer promotions or bonuses based on certain behaviors or behavior patterns (for example, rewarding loyal customer with a high purchase history, or offering a temporary discount to someone who has been observed considering a purchase for some time, but has not committed).

Further according to the embodiment, a pricing analysis engine 502 may be a computer comprising at least program code stored in a memory and adapted to perform analysis of at least a plurality of price value data, such as may be provided by a pricing engine 501 or retrieved from a database 506. Such analysis may comprise, for example, determining the “psychological friendliness” of pricing values, or analysis of price values with regard to known customer or user behaviors or activities such as to determine the effectiveness of a pricing strategy or user or demographic-specific pricing optimizations. Additionally, a pricing console 504 may be a computer comprising at least program code stored in a memory and adapted to receive interaction from a human user, for example via a software-based interface that may optionally present data from components of a system 500 as well as accept input such as to facilitate interaction with, or control of, other components of a system 500. In this manner, a user may be able to review the operations of various components or activities within a system 500, as well as provide input to assist in configuring or directing operations, for example to enable a human review analyst to further optimize operation using information external to a system (such as new policies that may affect pricing, for example).

Further according to the embodiment, an API 503 may communicate with program code stored and operating on a user's electronic device 508 (such as a personal computer, tablet computing device, smartphone, or any other of a wide variety of suitable electronic devices that may be capable of storing or operating program code and communicating via a network) such as via a digital packet network 507 (such as the Internet or other suitable communication network), for example to receive “ambient data” such as hardware or usage information from the device 508. For example, it is common in the art for a number of hardware sensors to be present on an electronic device such as a smartphone, such as for example a magnetometer, accelerometer, or any of a variety of radio communication hardware such as cellular or Wi-Fi antennas or modules. Such hardware may be used to, for example, provide usage information such as network utilization or location information, or any other such hardware data that may be relevant to pricing operations.

Below are a variety of examples of ambient data, illustrating various types and sources of customer and behavioral data that may be collected or analyzed according to the invention. It should be appreciated that the data types and values described are exemplary, and a wide variety of additional or alternate data may be utilized according to the invention.

### Ambient Data

This is information that is available on the Internet or via third party web services, that may be considered useful. It also changes infrequently, and the currency requirements are less stringent. Exemplary data types may include, but are not limited to: device Information—this is third party information about devices and may comprise size, resolution, CPU, memory, release date, MSRP, etcetera and a general notion of “is high end”; app store information or, more generally, ecosystem information—this may comprise metadata app stores make available about the applications (so, rank, category, user rankings, content ratings, studio, co-installs, historical information, size, etc.); FX Rates that may be used to normalize purchases to USD (to do this, exchange rates are needed); and geocoding and cost of living adjusted median household Income—another means of establishing affluence is to determine where an individual lives, works and spends their free time and the wealth of those locations (this information can be gathered from various datasets and varies by country). Additionally, by utilizing publicly available data sources, global census data may be obtained and utilized such as for identifying demographics for use in segmentation, and also a high-level “combined vocabulary” may be employed such as to facilitate combining collected data from multiple regions, languages, or cultures in a meaningful way for use by the system. For example, rather than simply identifying collected data using the source language, broad data types or fields may be identified and populated based on simple translation, and the data may then be utilized internally according to these more readily-interpreted data keys rather than the translation of their contents. It should be further appreciated that the configuration or operation of such a high-level language approach may be configurable or interactive, for example by employing translator users that can manually correct or submit translation information to aid in the accuracy or relevancy of data classification.

### Device Information

There are two major categories of device data—data that can be scraped from the phone and retail channel data that has to be gathered from external sources. Much of the data that can be scraped from the device is also contained in the datasets that contain retail channel data.

Types of data that can be collected from device or external database may comprise hardware specifications as well as software specifications. Types of data to collect that cannot be gotten from the device may comprise the release date of device, last date device was sold, or MSRP price information.

### App Stores

Public facing information can be collected from app stores such as ITUNES™ or GOOGLE PLAY™, for example including (but not limited to): general application scrapes such as app market, app category, or whether an app is a game or non-game; app-specific details such as app sub-category, permissions required by app, or other applications from developer; app statistics such as “users who viewed this also viewed X”, “users who installed this also installed X”, number of X star reviews, price, or size; content rating; current app version for given device; minimum OS version supported; or developer status (“top developer”, for example).

Internal developer account

Application data from a developer account may include (for example): app name; active installs; total installs; average rating; total number of ratings; crashes or other software failures; last update; current app status; or application details such as a store listing, pricing and distribution information, or in-app products, promotions, or purchases that may be available to a user.

### Financial Reports

The CSV download for financial reports may be an order level reporting. This data may be obtained from the Google Wallet order APIs and does not need to be scraped. Open source libraries that implement some scraping functionality may include PYTHON™, RUBY™, or JAVA™.

### Foreign Exchange Rates

Daily interbank rates are needed for all supported national currencies. The daily buy rate is sufficient. Zip code geocoding may also be used—both ANDROID™ and IOS™ have built in lat/long to zip code mapping, which may be used to gather median income data per zip code, or to perform metropolitan statistical area (MSA) to zip code mapping.

### Device

Device messages (such as may be sent from a messaging client to a messaging server for use according to the invention) may comprise (for example): device profile info such as manufacturer name, device ecosystem (generally one of ANDROID™, IOS™, WINDOWS™ or other mobile operating systems suitable for running software apps); device type information, generally one of phone, “mini” such as IPAD MINI™, tablet, television, or “traditional” (such as a non “smart” device such as a “feature phone” or a personal computer that does not fit any of the other type categories); device wallet information, generally one of GOOGLE PLAY™ ITUNES™, or AMAZON™; or hardware information such as device make and model name, CPU common name, CPU model number, amount of RAM, installed peripherals, amount of primary storage total, amount of secondary storage total, amount of primary storage free, amount of secondary storage free, amount of primary storage used, amount of secondary storage used, screen resolution, pixel density, screen size, OS version, SDK version, or locale information such as language or currency.

Some exemplary device messaging scenarios may include: “the DeviceProfile should be checked every time a session starts”; “the DeviceProfile should be versioned if differences are found between the last saved one and the current scan”; “a DeviceProfile message should be sent when the mobile SDK is first initialized”; “a DeviceProfile message should be sent if the DeviceProfile of the device is different from the one stored on the device”; or “smooth out data of storage used, may need sample size of 50 megabytes”.

Data that may be collected from external sources may include release date of device, last date device was sold, or how long has the user owned the device.

### Location

Exemplary location messages may include current location info such as device id, latitude, longitude, or local timestamp information optionally including timezone offset.

Exemplary location scenarios may include: “current location should be checked every time a session starts”; “a CurrentLocation message should be sent when the mobile SDK is first initialized”; “a CurrentLocation message should be sent if the current location of the device is different from the one stored on the device”; or “connectivity should be measured if detect device is in a new location”.

### Peripheral Device

Exemplary peripheral device messages may include manufacturer name, model name, or timestamp information. Data from external sources may comprise manufacturer name, release date of device, last date device was sold, or price information.

### Connectivity

Exemplary connectivity messages may include device id, “connectedness” (whether a device is connected or disconnected), device bandwidth, device bandwidth latency, whether the connection is via Wi-Fi or from a cellular network and other forms of wireless carrier information (for example, the specific cellular network vendor and the type of cellular network).

Exemplary connectivity scenarios may include: “current connectivity should be checked every time a session starts”; “a CurrentConnectivity message should be sent when the mobile SDK is first initialized”; or “a CurrentConnectivity message should be sent if the current location of the device is different from the one stored on the device”.

Exemplary user information may include a set of user profiles, or a set of owned devices. Additionally, a set of devices may be treated as an ordered list using “number of sessions” as the ordering criteria, such that the “n′th position” may represent “the most commonly used device in that day, by number of sessions”.

### User Profile

Exemplary user profile messages may include such information as a user id, name, gender, age, birthday, set of associated metadata tags, an application this profile is associated with, or user's “avatar” information (for example, characteristics associated with their in-app account profile) such as avatar race or name, or whether a user is registered. User information may also include app-specific metrics such as health, level, experience points or “xp”, creation date, or active date.

Exemplary user information scenarios may include: “the UserProfile should be checked every time a session starts”; “the UserProfile should be versioned if differences are found between the last saved one and the current scan”; “a UserProfile message should be sent when the mobile SDK is first initialized”; or “a UserProfile message should be sent if the UserProfile of the device is different from the one stored on the device”.

### Versioning

Version information on a user's owned device may include a device reference, a set of installed applications (people may not have the latest version of an application installed, and it may be important to know the true or current state of the applications installed), a set of installed substitute applications, or locale information.

### Installed Application

Installed application messages may include: a link to current application profile; a device ref; a timestamp of when application was started; a link to current application profile; or a timestamp of install.

Scenarios may include: “the installed applications should be checked every time a session starts”; “the installed applications should be versioned if differences are found between the last saved one and the current scan”; “a InstalledApplications message should be sent when the mobile SDK is first initialized”; “a InstalledApplications message should be sent if the InstalledApplications is different from the one stored on the device”; “the running applications should be checked every time a session starts”; “the running applications should be versioned if differences are found between the last saved one and the current scan”; “a RunningApplications message should be sent when the mobile SDK is first initialized”; or “a RunningApplications message should be sent if the InstalledApplications is different from the one stored on the device”.

Data from external sources

Data that may be inferred from external sources may include an app's rank at time of install, rating at time of install, count of all user reviews at time of install, or review information such as a count of X star reviews at time of install or a count of comments at install.

### Sessions

Session messages may include a session start timestamp or a session end timestamp.

Session scenarios may include: “start a new session if the application is visible to the user” (this happens when the application is started and is running in the foreground of the device); “stop a running session when application is not visible to user” (this happens when the application is in the background or is quit); “start a session if I perform an action that would require a session to be present” (any sessions created in this way are more authoritative, and the logic is that to perform any action such as manipulating a wallet balance would require the application to be on screen. If a session is started in this way log an event to the server as a warning of something that likely is not correct); “a new session should not be created if devices orientation changes”; “a new session should not be created when making a purchase”; or “a new session should not be created when checking notifications”.

Data inferred in relation to session events may include number of sessions per device, running applications, levels gained, xp gained, health change, tutorial completed true/false, is user registered, or time duration of use or play.

Application information may include an app id, app name, a link to the application icon, a links to each screenshot, or links to each video.

### Application Profile

Application metrics change over time. They also change in different ways in each country in which they are sold. Here are a couple stories for how to handle deltas:

Fields to collect may include an application category, application market, a set of other applications that the developer has on sale, a set of applications that users also viewed besides this one, a set of applications that users also installed besides this one, a set of substitute applications, a count of all user reviews, a count of X star reviews, a count of comments, the price, currency, country, application size. content rating, category, current app version for given device, minimum OS version supported, or number of installs.

Application ranking information may comprise an installation timestamp, as well as indicators as to whether the app is in top free, paid, grossing, new, trending, or other such categories.

Application category may comprise the app name as well as an app market it belongs to (such as ITUNES™ or GOOGLE PLAY™)

Monetization metrics collected may generally be of the form “nth spend” per metric, such as “per level”, “per minute in-game”, or other such associations.

### Data Collection

It may be desirable to scrape data from a user's device. Such data should not be limited to just device capabilities, but may also include installed software (and optionally usage patterns). This may be used to get core behavioral data from the user (for example, track all the currencies including in-app virtual currencies like “health” or “experience” points, or manage wallets for the currencies), to get session information (such as start, end, time playing, or other such metrics), or to have a set of additional pieces of data derived if the game developers call the methods (such as game data like levels or badges, or social data such as friends playing).

According to the invention, machine learning may be used to classify users in various ways. There's a hierarchy of classifications. Some of these are easy and some of them are hard. But remember, revenue maximization works when there is price sensitive demand and segmentable user bases. Price sensitivity is something that may be measured via A/B tests.

Segmenting users is learning (supervised and unsupervised). It may involve automated or semi-automated gathering of lots of data, classifying users in various ways, or using that classification to drive pricing policies.

### Machine Learning Interactions

The core of machine learning may be viewed as three things: summarizing current known information in “higher level” attributes (e.g. things like “Affluence”); deducing additional classification and structural attributes of users, which can be used to partition the set of users; and predicting future states of users. Especially with respect to churn and spend.

For each of these, create a unified communication framework that looks something like: data collection happens and data inserted into the database; some machine learning which consists of simple attribute summarization happens in Java; and everything that can be asserted or deduced by machine learning comprises a plurality of data points such as an attribute name, a set of defined values for the attribute, a default value for the attribute, whether or not it is ordered, whether or not it is numerical, what the enumerated values are if it's not numerical, or what the range limits are if it is numerical.

Asserting attributes about users happens “offline” (in the sense of “asynchronously form the main processing flow”) may follow the model that ad hoc is just code, and everything else may be weka models.

In defining where assertions “live”, it may be useful to utilize the concept of a virtual “redshift table” such as the exemplary layout shown below.

Table 1: Attribute definitions—as described above.

Table 2: Assertions. Consist of:
User
Attribute
Value
Confidence
Timestamp
Asserter

### Weka Models

These may be utilized to separate machine learning into three core areas: defining the attributes (this should ideally be done in a data driven way, such as by creating entries in an attribute definition table—doing this correctly makes it possible for the cohort definition system to automatically leverage the attributes, and makes it possible for the reporting system to leverage the attributes); doing exploratory data mining in (for example) R—it should be appreciated that learning the models and understanding the data variation is may be an exploratory task, best done within a statistical environment; and productizing the models.

### Detailed Description of Exemplary Embodiments

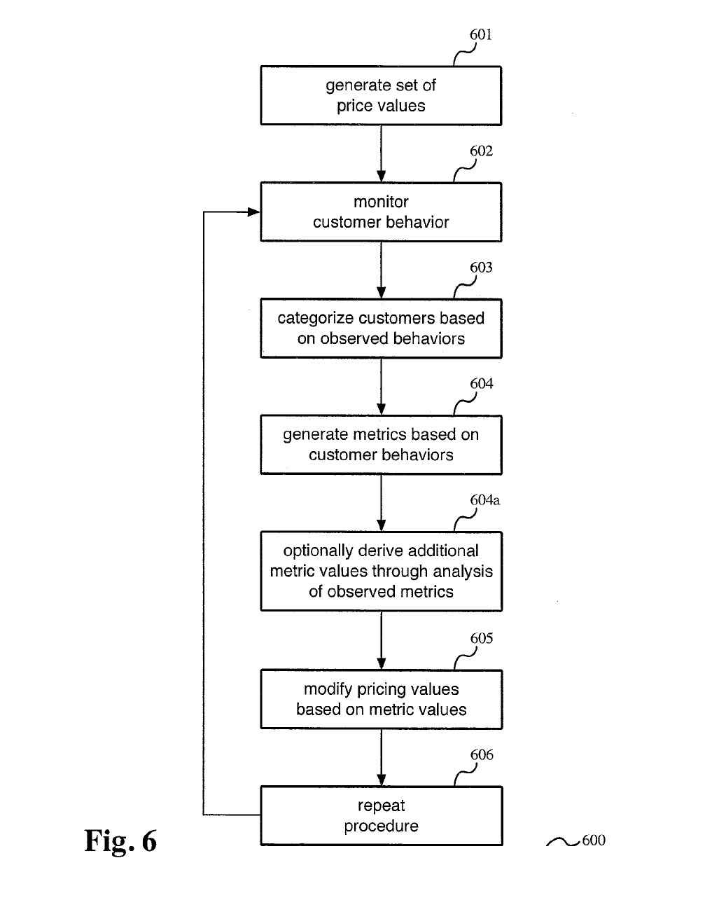

FIG. 6 is a method flow diagram illustrating an exemplary method 600 for adaptive pricing analytics, according to a preferred embodiment of the invention. In an initial step 601, a pricing engine may generate a set of price values, such as for use in a paywall for electronic entertainment. In a next step 602, customer behavior may be monitored such as by an API that may be communicating with or integrated with a user's device or external products or service a user may interact with. In a next step 603, a customer segmentation server may categorize or otherwise sort or organize users, based at least in part on behavior data such as collected in a previous step 602. In a next step 604, a pricing analysis engine may generate a set of metrics based at least in part on the behavior data or customer segments, for example generating and populating attributes based on observed patterns or specific behaviors. In an optional substep 604a, additional metrics or diagnostic data (for example, information relevant to testing operations such as historical values or trends such as customer behavior changes in response to changes in a paywall) may be derived from the initial metric set. In a final step 605, a pricing engine may modify existing price values or rules, based at least in part on the metric values. In this manner, pricing data may be dynamically updated in response to customer behavior and trends, while also adapting to changes caused by previous pricing updates, facilitating an automated or semi-automated dynamic pricing operation. In an optional iterative step 606, operation may continue in an iterative loop from a previous step 602, facilitating a continuous dynamic operation.

The following are a variety of exemplary metrics that may be used or derived according to the invention (as described above, referring to FIG. 6). It should be appreciated that a wide variety of potential data metric types or values may be utilized interchangeably according to the invention, and those described herein are merely exemplary.

### Forminⱼ a Metric Set

The invention may enable a much more precise and systematic terminology for measuring the impact of pricing decisions. Industry standard behavior is to track average revenue per daily active user (ARPDAU) and use that to define behavior. It may be desirable to systematically explore the space of potential prices, and that requires more fine-tuned metrics , or to utilize metrics or metric-based analysis to determine an overall “economic health” for a given user segment (for example, determining how “healthy” a segment is can be used to direct more relevant promotions or offers, or to customize other behaviors to tailor to their specific needs). A variety of exemplary metrics are listed below:

Average Purchase Index

Average Purchase Size

Four Week Spend/One Week Spend

Day 1 Conversion Rate

Day 3 Conversion Rate

Day 7 Conversion Rate

Day 14 Conversion Rate

Overall Conversion Rate

Second Conversion Rate

Third Conversion Rate

Fourth Conversion Rate

Percent Overdue

Percent Overdue For More Than Three Days

Average Day 1 Ending Value

Average Day 3 Ending Value

Average Day 7 Ending Value

Average Day 14 Ending Value

Average Day 21 Ending Value

Average Time to First Spend

Average Time from first to second spend

Average Time from second to third spend

Average Time between purchases

% whale

% dolphin

% minnow

% potential whale

% ideal customer

Percentage Paywall Abandonment

% Active Users

% At Risk Users

% Dormant Users

% Churned Users

Average time in game (minutes)

Average time in game (sessions)

Average time in game (days)

Average time in game (calendar days)

Time until 50% inactive

Time until 90% inactive

Average time until churned

Percent Who Spent Initial Grant

Percent Who Purchased Before Exhausting Initial Grant

Time to Spend Initial Grant

Days In Reserve in Wallet

Daily Spend Rate

7 Day TXN Count/WAU

Additionally, there are a variety of classic “funnel analysis” metrics that may be reinterpreted with improved granularity:

### 1. Overall

a. Number of Payment Wall Views

b. Number of Offer Takes

c. Number of Purchases

d. Number of Abandonments

e. Average time for succssful purchase

f. Average time for abandonment

g. Average Spend

h. Total Spend

### 2. Button Text Click and Convert

a. Number of users who've “seen” the button

b. List of button messages with their number of clicks

c. For each button, “successful purchase” percentage

3. For Each Cohort that's gone through the monetary policy (and overall)

a. Percentage of people who open a payment wall

b. Number of Payment Wall Views

c. Number of Offer Takes

d. Number of Purchases

e. Number of Abandonments

f. Percentage Abandonment

g. Average Spend

### 4. Anchoring

a. First Price in Wall

b. Default Price in Wall

c. Default Position in Wall

### 5. Positional Analysis

a. Take Rates By Position
i. First
ii. Second
iii. Third
iv. Fourth
v. Fifth
vi. Sixth

b. Average Spend by Position
i. First
ii. Second
iii. Third
iv. Fourth
v. Fifth
vi. Sixth

c. Abandonment Rates by Position
i. First
ii. Second
iii. Third
iv. Fourth
v. Fifth
vi. Sixth

### 6. Offer Type Analysis

a. Take Rates By Offer Type
i. MSRP
ii. Bonus
iii. Bonus Item
iv. Discount

b. Average Position for Offer Take
i. MSRP
ii. Bonus
iii. Bonus Item
iv. Discount

c. Average Spend for Offer Take
i. MSRP
ii. Bonus
iii. Bonus Item
iv. Discount

d. Abandonment Rates for Offer Take
i. MSRP
ii. Bonus
iii. Bonus Item
iv. Discount

### Statistical Significance

The invention makes it possible for e-commerce managers to manage prices of virtual currencies in free to play games. This involves a lot of moving pieces. But an important part of it is “reporting.”: automatically give charts with all the relevant numbers pre-computed for all important cohorts; whenever a cohort or payment wall differs significantly from the population, flag whether the difference is statistically significant; and let customer do arbitrary comparisons between two cohorts, or between a cohort and a past-time version of itself.

In order to motivate this, consider an exemplary metric: First Week Conversion Percentage. This has a pretty straightforward meaning: for a given cohort, the first week conversion percentage is the number of users in that cohort who made a purchase within their first week of play. Given two cohorts A and B, suppose that: A's first week conversion percentage is 0.04; B's first week conversion percentage is 0.08.

How can it be determined if this difference is meaningful? The first thing to do is get rid of the metric—the metric summarizes an underlying probability distribution, but is actually useless for computing significance. Instead, postulate two different maps: PA—map from A to {−1, 1} where “−1” means “didn't convert” and “1” means “converted”; PB—map from B to {−1, 1} where “−1” means “didn't convert” and “1” means “converted”.

The question is then: assuming both of these are really generated from binomial distributions, do they have the same underlying probabilities?

### The Usual Terminology

In a large number of statistical texts and papers, the methodology is that: the null hypothesis is that the two distributions are the same; the alternative hypothesis is that they're different; then construct a “test statistic” and compare it to a value range; and if the test statistic is outside the value range, you reject the null hypothesis (e.g. the two underlying distributions are probably different).

An additional important terminology concept is the idea of a “type 1” error and a “type 2” error: type 1—You say they're different, but they're really the same; and type 2—You say they're the same, but they're really different.

The value range is defined around keeping the probability of a type 1 error very low. In other words: unless you're very certain that things are different, assume they're the same.

### UserSample

This is a set of users. It may be defined by:

Creation date range.

A set of positive segments

A set of negative segments

A size (# of users)

These may be defined separately, and given an identity, so that they may be tracked over time. It is reasonable to download data sets about the same users over time (also to download data about different users). Once the definition is asserted via an API, may choose the users immediately, using a flat distribution (find all users meeting criteria, pick subset with no bias).

### DataSample

A datasample may be defined using: a UserSample (what users to get data for); a start date; a pivot date; and an end date.

Given this sample, return: background data (optional, via flag). Device info, google play info, payment wall and pricing component info (name, id, description, and URL to view complete object in admin tool should be enough); the complete user state at 12:00:01 AM of those three dates. This includes all segments the user is in, all game state (health, xp), all wallet balances, all lifetime totals, ideally a complete snapshot of the user; all sessions that occur in the date range, with session-oriented counters; and all monetary events that occur within the session. Ideally, anything that happens that impacts a virtual currency balance, such as RMT purchases, grants they make using the API, or purchases they make using the API.

### First Pass At User Flow (API Requirements)

May support a REST API that enables the following operations:
Get all user samples. Returns names, ids, metadata (# of members, . . . ). Does not actually return user objects.
Create user sample. This returns an id that can be used to reference the user sample. Will fail if they already have their max number of samples defined.
Delete user sample.
Get specific user. Returns data for specific user.
Get segment list. Returns named list of segments.
Create data Sample. Returns an id of the sample.
Get available samples. Returns metadata about samples that are available (we're going to create samples as zips and store them for up to 5 days. So this lists all the available ones).
Is sample done. Enables polling.
Download data sample.

### Classical Testing is the Wrong Approach

Classical A/B model testing is wrong, as the world is non-stationary. Instead, classical multi-armed bandits are a more appropriate approach to testing: this is how web-optimization is done (ad placement); this is how the economists talk about things when they theorize; and even so they're wrong too—assume a known, small, and essentially independent set of choices to choose from (“given these 17 units of essentially unrelated advertisement, optimize”).

Punctuated Multi-Arm Bandit testing will typically comprise an iterative loop, utilizing a multi-arm bandit to gather information—to cycle through exploring or exploiting behavior across many alternatives. Then, testing may utilize select or regeneration behavior: utilize the state-space parameterization of payment walls and objects; utilize the deep metrics for “goodness of fit” and maximizing lifetime value; this phase subsets the current population and generates some new experimental values; and use either genetic algorithms or some other form of search/hill-climbing algorithm. Lastly, testing may also employ conjoint analysis: deep analogy between payment walls and typical items in a conjoint analysis experiment, which enables use of classical marketing analysis algorithms on big data price and purchase sets.

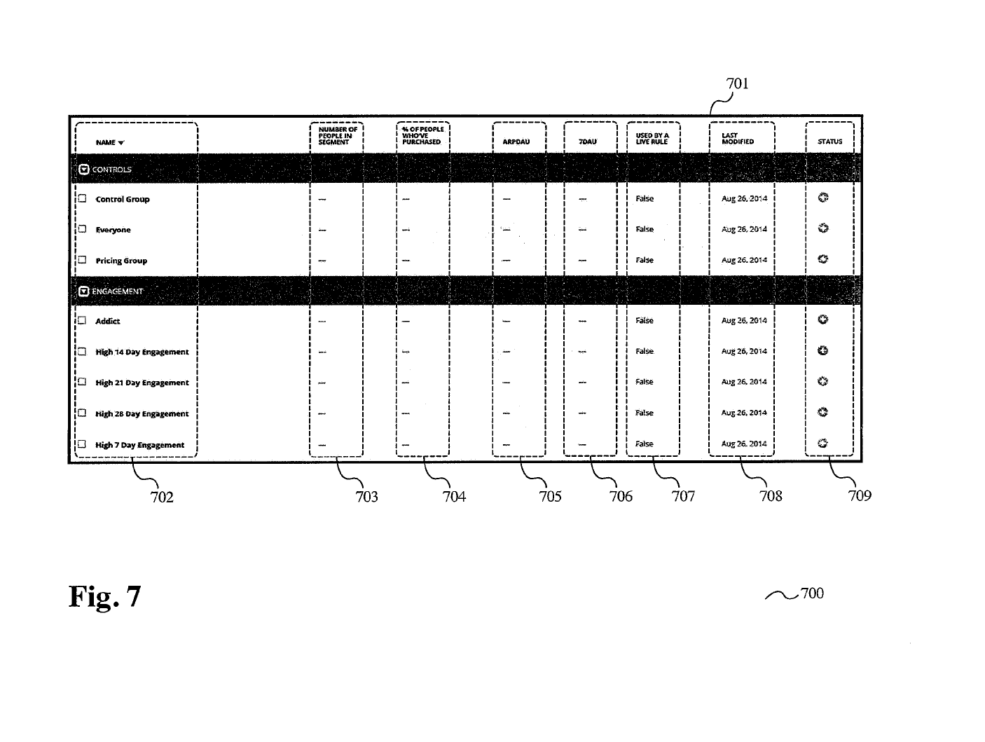

FIG. 7 is an illustration of an exemplary user interface 700 for viewing parameterized pricing rules. As illustrated, an interface 700 may comprise a pricing rule display 701 that may be adapted to present a plurality of pricing rules in a read-only or interactive manner for a human user, interchangeably according to a particular arrangement. Information presented via a display 701 may comprise a plurality of pricing rules 702, which as illustrated may be organized or sorted for ease of comprehension by a human user, for example according to preconfigured rules or categories, or based on search or sort criteria that may have been provided by a user (for example, if a user wishes to see all rules pertaining to a particular product or for a particular user group or region). Each pricing rule 702 may further comprise a plurality of data values that may be presented in an orderly fashion, for example as illustrated the rules may comprise user segment information such as quantity of users in a segment 703, or user behavior statistics such as purchase rate 704, average revenue per daily active user (“ARPDAU”) 705, active users within a time period 706 (such as within the last 7 days, as illustrated), whether the pricing rule is in use 707, a creation or modification date or timestamp 708, or a status indicator 709 such as to summarize other rule attributes or values for quick viewing (for example, a visual indicator that changes based on the age or deployment status of a rule). In this manner, a display 701 may present a simple, easily understood and informative interface for viewing pricing information according to the invention.

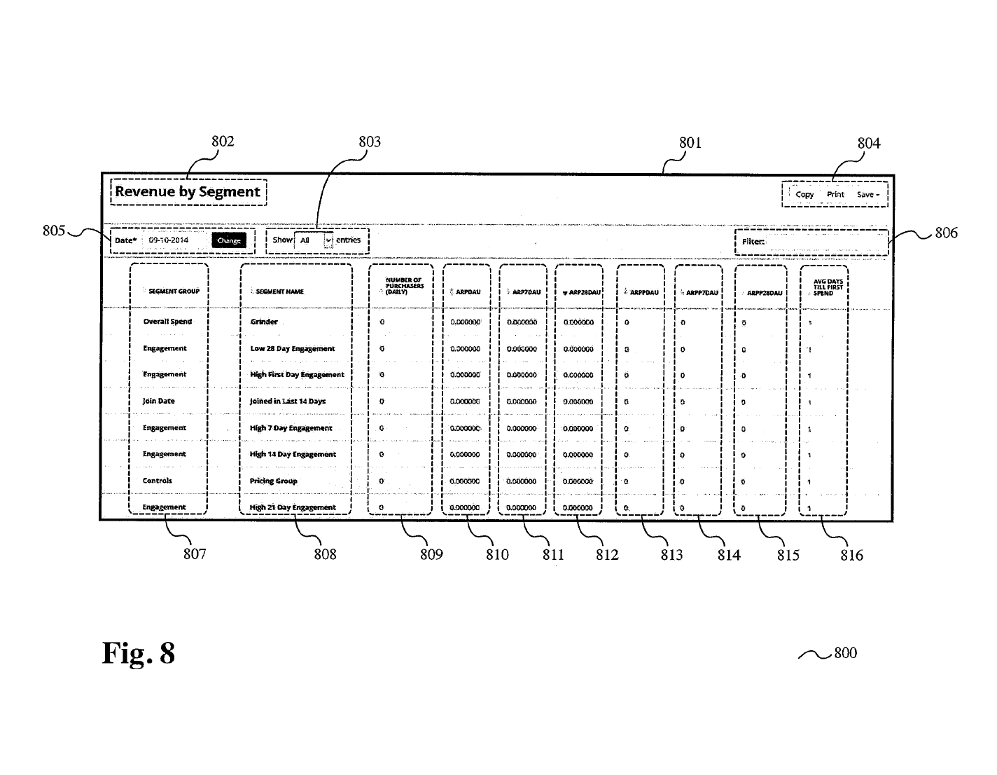

FIG. 8 is an illustration of an exemplary user interface 800 for viewing customer segments. As illustrated, an interface 800 may comprise a customer segment display 801 that may be adapted to present a plurality of customer segment information in a read-only or interactive manner for a human user, interchangeably according to a particular arrangement. Information presented via a display 801 may comprise a title or heading 802 to indicate currently-displayed content, controls for exporting or copying the information 804, or interactive controls to change the content displayed such as date or time selection 805, segment selection 803, or search query or filter input controls 806.

Displayed content may further comprise a plurality of customer segments 807 (which may themselves be groups of sub-segments in a hierarchical organization arrangement), which as illustrated may be organized or sorted for ease of comprehension by a human user, for example according to preconfigured rules or categories, or based on search or sort criteria that may have been provided by a user (for example, if a user wishes to see all user segments associated with a geographical region, or segments that frequently make a certain quantity, value, or type of purchase). Each segment or segment group 807 may further comprise a plurality of data values that may be presented in an orderly fashion, for example as illustrated the rules may comprise user segment information such as a segment name or descriptor 808 or user behavior statistics for those within the segment such as purchase rate 809, average revenue per daily active user (“ARPDAU”) 810, active users within a time period such as within the last 7 days 811 or 28 days 812, as illustrated), average revenue per purchase 813 (“ARPP”) or ARPP within a timeframe such as the last 7 days 814 or 28 days 815, or average length of time until a first purchase 816 for users within the segment. In this manner, a display 801 may present a simple, easily-understood and informative interface for viewing pricing information according to the invention.

The skilled person will be aware of a range of possible modifications of the various embodiments described above. Accordingly, the present invention is defined by the claims and their equivalents.

What is claimed is:

1. A system for adaptive pricing analytics via a dynamic pricing system, comprising:
a pricing engine computer comprising program code stored in a memory and adapted to generate at least a plurality of parameterized price values;
a pricing console computer comprising program code stored in a memory and adapted to operate an interface for receiving user interaction;
a customer segmentation server computer comprising program code stored in a memory and adapted to receive customer interactions via a digital packet network and to generate customer behavior data values based at least in part on those interactions, and to provide the behavior data values to the pricing engine;
a database computer comprising program code stored in a memory and adapted to store information from the other components of the system; and
a pricing analysis server computer comprising program code stored in a memory and adapted to analyze at least the price values and provide the analysis results to the pricing console.

2. The system of claim 1, wherein the pricing engine produces price values based at least in part on the behavior data values.

3. The system of claim 1, wherein the customer segmentation server stores the behavior data values in the database for future reference.

4. The system of claim 1, wherein the customer segmentation server generates user segments based at least in part on the behavior data.

5. The system of claim 4, wherein the price values are based at least in part on the user segments.

6. The system of claim 1, wherein the pricing analysis server analyzes at least the behavior data values.

7. The system of claim 6, wherein the customer segmentation server generates a metric set based at least in part on the behavior data values.

8. The system of claim 6, wherein the pricing analysis server generates diagnostic values based at least in part on the behavior data values.

9. The system of claim 6, wherein the price values are based at least in part on the metric set.

10. The system of claim 1, wherein the pricing analysis server generates recommendations based at least in part on the analysis results.

11. The system of claim 10, wherein the recommendations are provided to the pricing console for viewing by the user.

12. The system of claim 11, wherein the recommendations are stored in the database for future reference.

13. The system of claim 1, further comprising a software API comprising program code stored in a memory and adapted to collect customer behavior data values via a digital packet network and provide the customer behavior data to the customer segmentation server.

14. The system of claim 13, wherein the API is installed on a user's electronic device.

15. The system of claim 14, wherein the API collects available data values from the user's electronic device and provides those data values to the customer segmentation server via a digital packet network.

16. The system of claim 15, wherein the data values comprise at least a customer device's hardware capabilities.

17. The system of claim 16, wherein the data values further comprise at least changes to a customer's device over time.

18. The system of claim 13, wherein the API receives ambient data values from a plurality of customer devices via a digital packet network, the ambient data values comprising at least a plurality of data values readily available on the customer device.

19. The system of claim 13, wherein the API receives a plurality of behavior data values from external software services via a digital packet network.

20. The system of claim 19, wherein the external software services comprise at least a social media content network.

21. The system of claim 19, wherein the external software services comprise at least a software application store.

22. A method for adaptive pricing analytics, comprising the steps of:
Generating, using a pricing engine computer comprising program code stored in a memory and adapted to generate at least a plurality of parameterized price values, an initial set of pricing values;
receiving, at a customer segmentation server computer comprising program code stored in a memory and adapted to receive customer interactions via a digital packet network and to generate customer behavior data values based at least in part on those interactions, and to provide the behavior data values to the pricing engine, a plurality of customer data values;
categorizing customers based at least in part on received data values;
generating a metric set based at least in part on the received data values; and
updating the pricing values based at least in part on the metric set.

23. The method of claim 22, further comprising the steps of:
analyzing, using a pricing analysis server computer comprising program code stored in a memory and adapted to analyze at least the price values and provide the analysis results to the pricing console, the metric set;
generating a plurality of derived metric values from the analysis results; and
updating the dynamic price values based at least in part on the derived metric values.

24. The method of claim 23, further comprising the step of repeating the method in an iterative loop.
